(19) United States
(12) Patent Application Publication
(10) Pub. No.: US 2007/0217607 A1
(43) Pub. Date: Sep. 20, 2007

(54) Repetition Coded Compression For Encrypting Highly Correlated Data

(75) Inventor: Arvind Thiagarajan, Tamil Nadu (IN)

Correspondence Address: SEED INTELLECTUAL PROPERTY LAW GROUP PLLC, 701 FIFTH AVE, SUITE 5400, SEATTLE, WA, 98104, US

(73) Assignee: Matrixview Limited, Singapore (SG)

(21) Appl. No.: 10/589,440

(22) PCT Filed: Feb. 14, 2005
(86) PCT No.: PCT/SG05/00037

§ 371 Date: May 29, 2007

(30) Foreign Application Priority Data
Feb. 15, 2004 (IN) 1012/CHE/2003
Apr. 15, 2004 (IN) 335/CHE/2004
Apr. 15, 2004 (IN) 338/CHE/2004
Apr. 15, 2004 (IN) 337/CHE/2004
Apr. 15, 2004 (IN) 339/CHE/2004
Jun. 15, 2004 (IN) 336/CHE/2004

(51) Int. Cl. H04N 7/167

(52) U.S. Cl. 380/217

(57) ABSTRACT

A method for an encryption of highly correlated data using a repetition coded compression is disclosed. The method includes the steps of receiving digital data, reshaping the digital data into a digital data matrix, encoding the repetitions of elements in the digital data matrix into a bit-plane index to form a compressed data, adding an encryption layer to mathematically manipulate the compressed data, and storing the compressed data in a storage memory in an encrypted form.

### TECHNICAL FIELD

The present invention relates to a method and system of encrypting highly correlated data streams.

### BACKGROUND OF THE INVENTION

Data compression is of vital importance and has great significance in many practical applications.

Security is a significant issue in image compression. Applications such as video-on-demand, pay-per-view and medical imagery require data protection in addition to compression. For example, in a medical imaging application, modern healthcare standards like HI7 and DICOM make it compulsory to store patient details for up to five years. It is necessary to compress images to save storage space. Also, it is necessary to ensure that the transmission and storage of these images are secure to maintain the sacrosanct nature of the patient details.

Encryption is a secure and trusted method for storing highly sensitive information privately. Encryption is a reversible process by which bits of data are mathematically scrambled and unscrambled using a password key. Encryption transforms the data so that it is unreadable and unintelligible until it is decrypted. Most encryption involves authentication and aims to identify images or documents and their routing through a network. This involves retaining small packages of information in secure form during transmission and remote access.

Some encryption techniques include digital watermarking, RSA, Pretty Good Privacy (PGP) and DES. Digital watermarking consists of modifying the original data, and embedding a watermark in the original data. PGP is an open source encryption standard that generates a key pair: a public key and a private key. PGP requires additional transmission of public keys along with the encrypted data. However, this additional transmission results in added data overhead. These prior art encryption techniques involve complex algorithms which require additional computational processing power. Also, these and other encryption techniques involve passwords that may be predictable which make them vulnerable for security to be compromised.

Existing open image compression standards are not designed allow the addition of an encryption layer. So when compressed files are encrypted, they do not conform to the open standard and the advantages of using an open standard are not enjoyed.

### SUMMARY OF THE INVENTION

In accordance with a preferred aspect there is provided a method for encrypting highly correlated data wherein each element is compared with a previous element. If they are both equal, a first value is recorded. If they are not both equal, a second value is recorded. The first value may be a 1, and the second value may be a 0. An encryption layer is added to mathematically manipulate the compressed data.

Data compression using RCC is closely related to data encryption. In contrast to data compression where the objective is to reduce the volume of data and achieve reproduction of the original data without any perceived loss in data quality, the objective of data encryption is to transform data into an unreadable and unintelligible form to ensure privacy.

The data may be image data. If image data is encrypted, each element may be a pixel. The first and second values may be stored in a bit plane. A bit plane refers to the memory in a graphic display device which holds a complete one-bit-per-pixel image. Several bit planes may be used in conjunction to give more bits per pixel or to overlay several images or mask one with another. “Bit plane” may sometimes be used as a synonym for “bitmap”. For a one-dimensional compression, a single bit plane may be used to store the values. However, for a two-dimensional compression, comparison may be in both horizontal and vertical directions, a separate bit plane being used for each direction.

The bit-planes for the horizontal and vertical directions may be combined by binary addition to form a repetition coded compression bit-plane. Combining may be by binary addition, only the second values being stored for lossless reconstruction of the image. The result of the combining may be repetition coded compression data values. All other image data values may be able to be reconstructed using the repetition coded compression data values, and the bit planes for the horizontal and vertical directions.

Storage in bit planes may be in a matrix. A single mathematical operation may be performed for each element.

In accordance with a further aspect, there is provided an encryption system for encrypting highly correlated data using repetition coded compression, the system comprising a data receiver for receiving digital data; a reshaping block for rearranging the digital data into a matrix of data values; a processor for receiving the matrix of data values and compressing the data values to form compressed data; and a memory for storage of the compressed data, an encryption module for adding an encryption layer to mathematically manipulate the compressed data.

In accordance with another aspect, there is provided a method for encrypting data comprising receiving digital data. The digital data is reshaped into a digital data matrix. Repetitions in the digital data matrix and encoded into a bit-plane index, and stored data values. The compressed data is stored in a storage memory in an encrypted form.

The bit-planes may contain information regarding the repetitions along horizontal and vertical directions. There may be further included the combining of the horizontal and vertical bit-planes by a binary addition operation to give a repetition coded compression bit-plane. There may also be included comparing the repetition coded compression bit-plane with the digital data matrix to obtain final repetition coded compression data values.

The method may further include storing and archiving the repetition coded compression data values along with the horizontal and vertical bit-planes.

The method may be used for an application selected from: medical image archiving, medical image transmission, database system, information technology, entertainment, communications applications, and wireless application, satellite imaging, remote sensing, and military applications.

Both the forward and reverse compression processes of RCC ensure privacy and allowing secure communication of compressed data. ensuring privacy allowing secure communication of compressed data

RCC does not utilise complex modelling and coding models. RCC provides a secure transmission of highly correlated data and images with encryption and decryption on the fly. RCC uses simple, logical transformations and mathematical operations that make the entire algorithm simpler in comparison to the JPEG family of standards and other wavelet transforms.

Advantageously, RCC encryption has been developed to be used without any additional network equipment of application software. This allows compression, encryption and decompression on the fly without any loss of time and increase in storage requirements.

The RCC encryption process offsets any losses due to processing overhead, as it does not require extra time or bits. This allows compression, encryption and decompression on the fly without any loss of time. The RCC encryption system encrypts without reformatting or converting the image, text or data. RCC encryption uses bit planes to shift the bits within the bit planes, and even the bit planes themselves can lead to techniques that can simultaneously provide security functions and an overall visual check. Encryption is simultaneous, executed at the same time as the encoding process, thus no added latency affects the speed performance. The RCC algorithm provides inherent encryption for a secure and lossless transmission. RCC encryption may be used together with Adaptive Binary Optimisation (ABO). Alternatively, a third party encryption layer may be added to increase data security.

When data is encoded and encrypted, a corresponding decryption methodology is generated. This makes each decoder unique to the encrypted data. A Public Key Infrastructure (PKI) approach may be utilised to enable distribution and sharing of encrypted data. The use of security keys such as USB dongles can further be deployed to minimise the issue of piracy and enable data such as music and video to be portable and shared by legitimate consumers.

Applications

RCC can be used in applications for medical imaging, digital entertainment and document management. Each of these verticals requires RCC to be implemented in a unique way to deliver a robust and powerful end product.

RCC can be deployed in the following forms for commercialisation:

1) ASIC or FPGA chips

2) DSP or embedded systems

3) Standalone hardware boxes

4) Licensable software (as DLLs or OCX)

5) Software deliverables

### BRIEF DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings in which:

FIG. 1 illustrates the entire image compression system based on repetition coded compression on a hardware implementation;

FIG. 2 is a sample grayscale image of a human brain, which is captured by magnetic resonance imaging (“MRI”) to demonstrate the compression able to be achieved by repetition coded compression system;

FIG. 3 is an enlarged image of a small region from FIG. 2;

FIG. 4 shows that the image of FIG. 2 is made up of many pixels in grayscale;

FIG. 5 shows a 36-pixel region within the sample MRI image of FIG. 2;

FIG. 6 shows the ASCII value equivalent of the image data values for the image of FIG. 2;

FIG. 7 shows the application of repetition coded compression along the horizontal direction in the image matrix;

FIG. 8 shows the application of repetition coded compression along the vertical direction in the image matrix;

FIG. 9 shows the combination of horizontal and vertical bit-planes by a binary addition operation;

FIG. 10 shows the total memory required for the 36-pixel region before and after applying repetition coded compression;

FIG. 11 shows the application of repetition coded compression to the entire image;

FIG. 12 shows the operational flow for the implementation of repetition coded compression;

FIG. 13 is a process flow diagram of the optimisation process for compressing image data;

FIG. 14 is a block diagram of a system for optimising compression of image data;

FIG. 15 is an example of an image to compress using RCC;

FIG. 16 is a graph of an even distribution of the R component of the image of FIG. 15;

FIG. 17 is a graph of the R component of the image of FIG. 15 after RCC compression which shows non-uniform distribution;

FIG. 18 is a graph of the G component of the image of FIG. 15;

FIG. 19 is a graph of the G corhponent of the image of FIG. 15 after RCC compression;

FIG. 20 is a graph of the B component of the image of FIG. 15;

FIG. 21 is a graph of the B component of the image of FIG. 15 after RCC compression;

FIG. 22 is a process flow diagram of the RCCP encoding method;

FIG. 23 is a process flow diagram of the RCCP decoding method;

FIG. 24 is a process flow diagram of searching for an RCC value;

FIG. 25 is a process flow diagram of the RCCA encoding method;

FIG. 26 is a process flow diagram of the RCCA decoding method;

FIG. 27 is a process flow diagram of a first RCC encryption method; and

FIG. 28 is a process flow diagram of a first RCC encryption method;

### DETAILED DESCRIPTION OF PREFERRED EMBODIMENTS

Image data is highly correlated. This means that more often than not, adjacent data values in an image are repetitive in nature. Therefore, it is possible to achieve compression from this repetitive property of the image and then apply Huffman coding or other source coding schemes. High compression ratios can be achieved by combining existing data transforms and source encoders.

After compression, a software encryption module (not shown) adds an encryption layer to the compressed data, which mathematically manipulates the compressed data into an encrypted form.

The human eye is more sensitive to luminance than colour. Thus, chrominance luminance and value format offers an additional compression technique. This technique uses colour transformations in image compression to generate visually lossless methods. Using lossy colour transformation provides an effect equivalent to that of quantization of other techniques in the sense that it cannot resolve the difference between small values. That is, the same integer value is used for two different integer values with a small difference. As a result of this, repetition occurs at a 24-bit level. Increasing repetition in image data provides a high compression ratio. However, one drawback to this technique is that it is not reversible perfectly, that is, it is lossy. In other words, the decompressed image data is different from the original image data. The degree of difference is dependent upon the quality of compression and also the compression ratio. The adjustment of the quality may be user-defined by setting a quality parameter such that a very highly compressed visually lossless image is produced. By visually lossless we mean that the image data is technically lossy but to the human eye the image appears lossless.

A method for indexing a bit plane is provided which is flexible as it can be applied to a wide range of image types and formats. These image types include bi-level, grayscale, 8/16/24 bit colour and medical images. The method is scalable as no change to the structure of the process is required for the various image types.

Bit plane indexing creates a redundant array of only zeros and ones. This improves the compression ratio without any loss or increase in the data set. This step is critical to obtain a high compression ratio to respond to speed.

In the bit plane indexing process, the raw original image data is decomposed to various types of bit planes. For example, these include horizontal, vertical or a combination of both, in an integer-to-integer matrix. A bit plane of zeros and ones is obtained along with the index of the image. The original image can be reconstructed perfectly losslessly with the index and the bit plane. The choice of which bit plane to use is dependent on the application or final product.

Bit plane indexing creates two arrays of codes. One array represents the index of the rearranged and sorted image. The second array is a set of zeroes and ones that form the bit plane.

Thus, the original image data is decomposed to one or more bit planes and stored along with an index of the image. The reconstruction is performed losslessly using the index and the bit plane.

In repetition coded compression (RCC), each element is compared with the previous element. If both of them are equal then a value of “1” is stored in a bit-plane. Otherwise a value of ‘0’ is stored in the bit-plane. Only the difference value is stored in a matrix, instead of storing all the repeating values.

In a one-dimensional performance of the method, only one bit-plane is used to code the repetition. RCC horizontal transformation, RCC vertical transformation and RCC predict transformation are classified as RCC in one dimension.

In a two-dimensional performance of the method, two bit-planes are used to code the repetitions in both the horizontal and the vertical directions. This is more efficient and gives a better compression ratio.

RCC Horizontal

In RCC horizontal transformation only one bit-plane is used to code the repetition of values. That is, the bit-plane is in the horizontal direction only. In the RCC horizontal transformation, adjacent data elements, for example, pixels in the case of images, are scanned in raster order (from left to right and then from top to bottom). If both adjacent data elements are equal, then a value of “1” is stored in the matrix or bit plane. Otherwise if they are not equal, a value of “0” is stored in the bit plane matrix. Only this different value is stored in the bit plane matrix instead of storing all the repeating values. Transforming the input data into a bit plane provides a greater amount of repetition than the original image data.

The RCC horizontal transformation only requires a logical mathematical comparison and no other mathematical calculation. The transformation falls within the integer-to-integer domain so as to maintain the lossless nature of the process. This process is ideal for images because a pixel is represented by 8 bits. When a logical transformation performed maps the pixel to another number, only 8 bits are required to be represented. This process preserves the lossless nature of the transform.

A horizontal variant is one dimensional by nature. Only one bit-plane is used to code the repetition of values. That is, the bit-plane is in the horizontal direction only. In the horizontal variant, adjacent data elements, for example, pixels in the case of images, are scanned in raster order (from left to right and then from top to boftom). If both adjacent data elements are equal, then a value of “1” is stored in the matrix or bit plane. Otherwise if they are not equal, a value of “0” is stored in the bit plane matrix. Only this different value is stored in the bit plane matrix instead of storing all the repeating values. Transforming the input data into a bit plane provides a greater amount of repetition than the original image data.

RCC Vertical

RCC vertical transformation is similar to the RCC horizontal transformation described except that image data is compared in a non-raster order. This transformation still preserves the lossless nature of the transform.

A vertical variant is similar to the horizontal variant transformation described except that image data is compared in a non-raster order. This transformation still preserves the lossless nature of the transform.

RCC Multidimensional

A multidimensional bit plane performs a combination of the horizontal and vertical bit planes. In some cases, it is able to achieve improved compression ratios than just using either a horizontal or vertical bit plane. Firstly, the RCC horizontal transformation is performed and stores the generated bit plane as a horizontal bit plane. Next, a RCC vertical transformation is performed and the generated bit plane is stored as a vertical bit plane. A logical “OR” is performed on the two bit planes and stored as a lossless compressed multidimensional bit plane. A “NOT” operation is performed between the multidimensional bit plane and the original image matrix. Both the “OR” and “NOT” operations maintain the integrity of the image data and still preserves the lossless nature of the transform.

Thus, the original image data is decomposed to one or more bit planes and stored along with an index of the image. The reconstruction is performed losslessly using the index and the bit plane.

The compression system is based on a mathematical comparison of adjacent image data values. The comparison is performed between adjacent image data values in both the horizontal as well as vertical directions. The bit-planes formed as a result of the comparison in the horizontal and vertical directions are respectively combined by a binary addition method. After this the resultant bit-plane positions are called as RCC bit-planes. The zero values in the RCC bit-plane are stored for lossless reconstruction of the original image. For lossless reconstruction, they are the only values stored. The stored values correspond to the same locations in the original image matrix as zeros in the RCC bit-plane and are hereinafter called RCC data values. All the other image data values can be reconstructed by using the RCC data values, and the horizontal and vertical bit-planes.

FIG. 1 illustrates the entire image compression system based on RCC for a hardware implementation. Analog image signals 12 are captured by a camera 10 and converted into corresponding digital data 16 by an analog to digital converter 14. This digital data 16 is rearranged into a matrix of image data values by a reshaping block 18. The reshaped image matrix is stored in an embedded chip 20, which performs the entire RCC process. This therefore gives the compressed RCC data values 22 and also the bit-planes of data 24 for storage, archival and future retrieval 26.

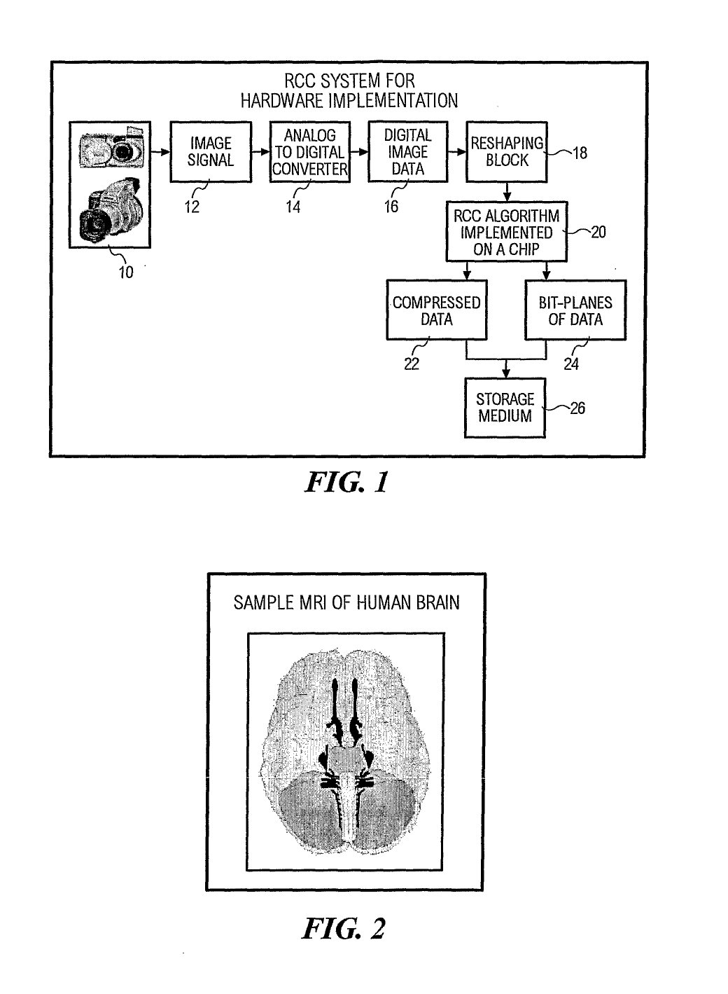

FIG. 2 is a sample image of the human brain which is captured by a magnetic resonance imaging (MRI) scan. As one example, this sample image is used to demonstrate the compression achieved by RCC. The MRI scan is a grayscale image.

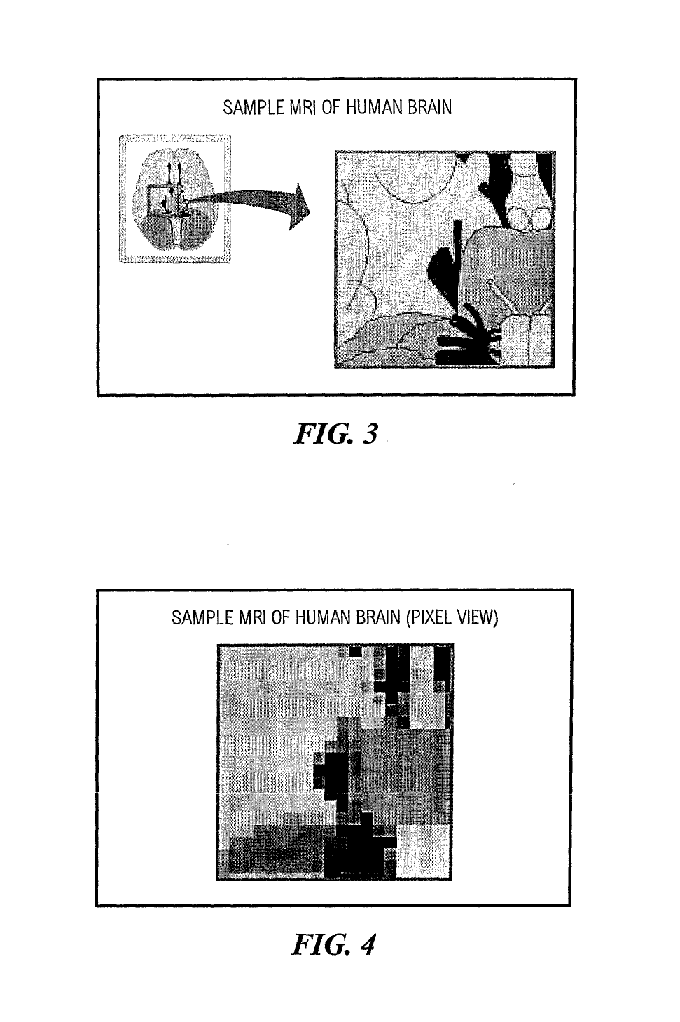

FIG. 3 zooms a small region from the sample MRI scan of the human brain. This zoomed region is also be used for demonstrating the RCC system.

FIG. 4 shows that the image is made up of many pixels in grayscale.

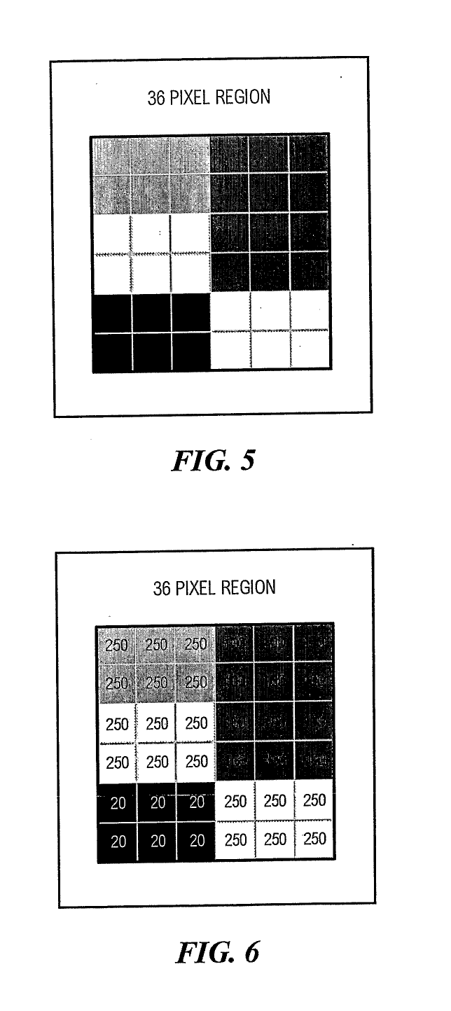

FIG. 5 shows a 36-pixel region within the sample MRI scan of the human brain.

FIG. 6 shows the ASCII value equivalents of the image data values which are originally used for data storage. Each value requires eight bits (1 byte) of data memory. Currently, the 36-pixel region requires about 288 bits or 36 bytes of data memory. That data could be compressed and stored with only 112 bits after RCC.

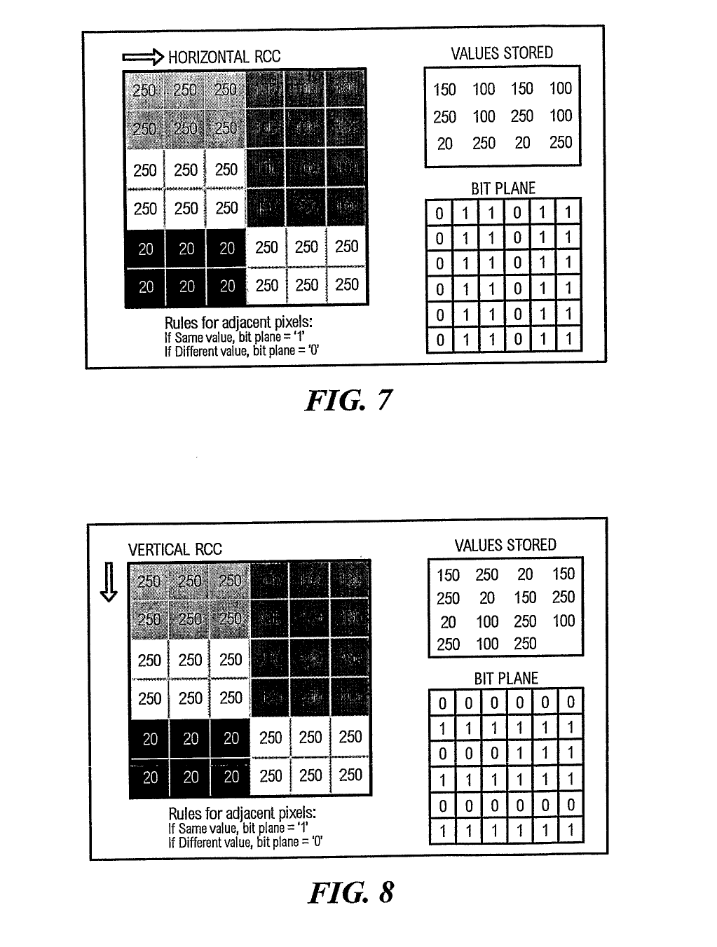

FIG. 7 shows RCC being applied along the horizontal direction in the image matrix. This results in the horizontal bit-plane and also the horizontal values stored.

FIG. 8 shows RCC being applied along the vertical direction in the image matrix. This result in the vertical bit-plane, and also the vertical values stored.

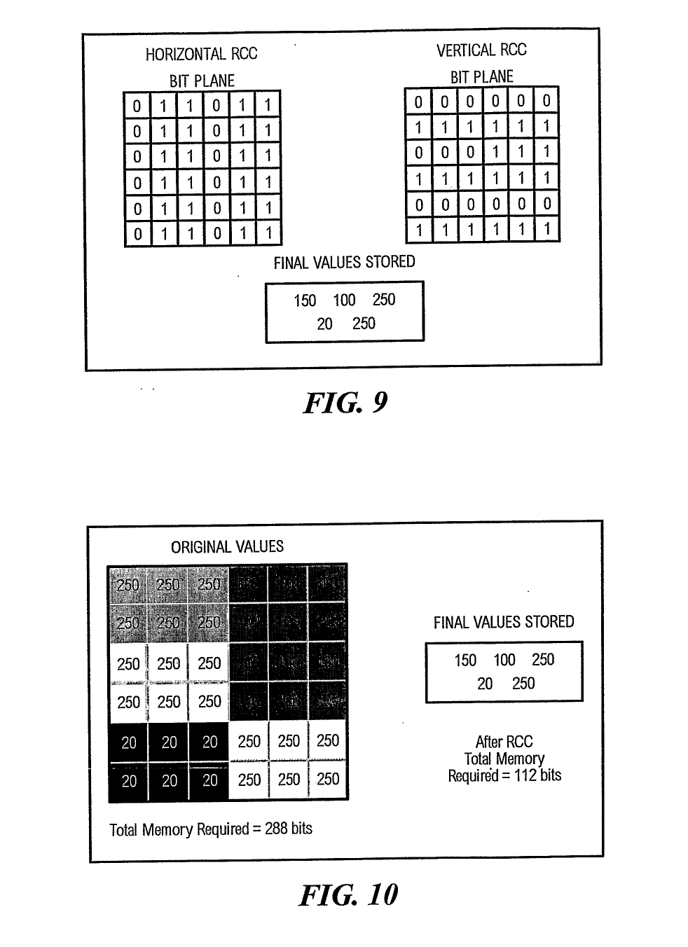

FIG. 9 shows the combination of horizontal and vertical bit-planes by a binary addition operation. This results in only five zero values which correspond to the final values stored from the original image matrix.

FIG. 10 shows the total memory required for the 36-pixel region before and after applying RCC. The original memory requirement was 288 bits. After applying RCC, the memory required was 112 bits. This is a significant amount of compression.

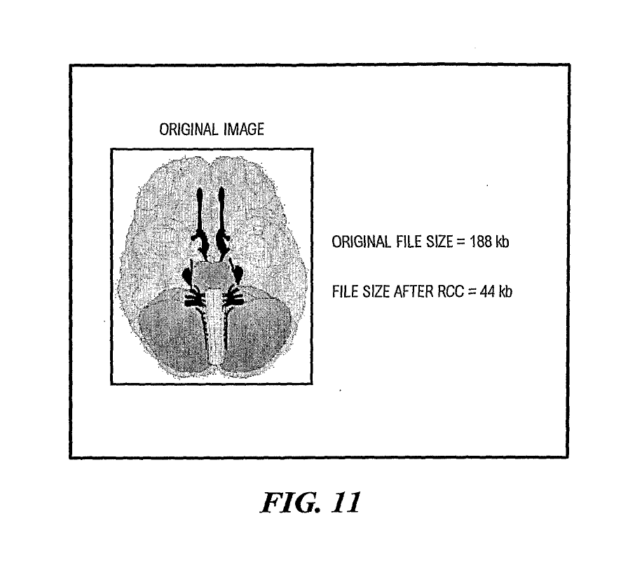

FIG. 11 shows RCC being applied to the entire image. The size is compressed to 44,000 bits from the original 188,000 bits.

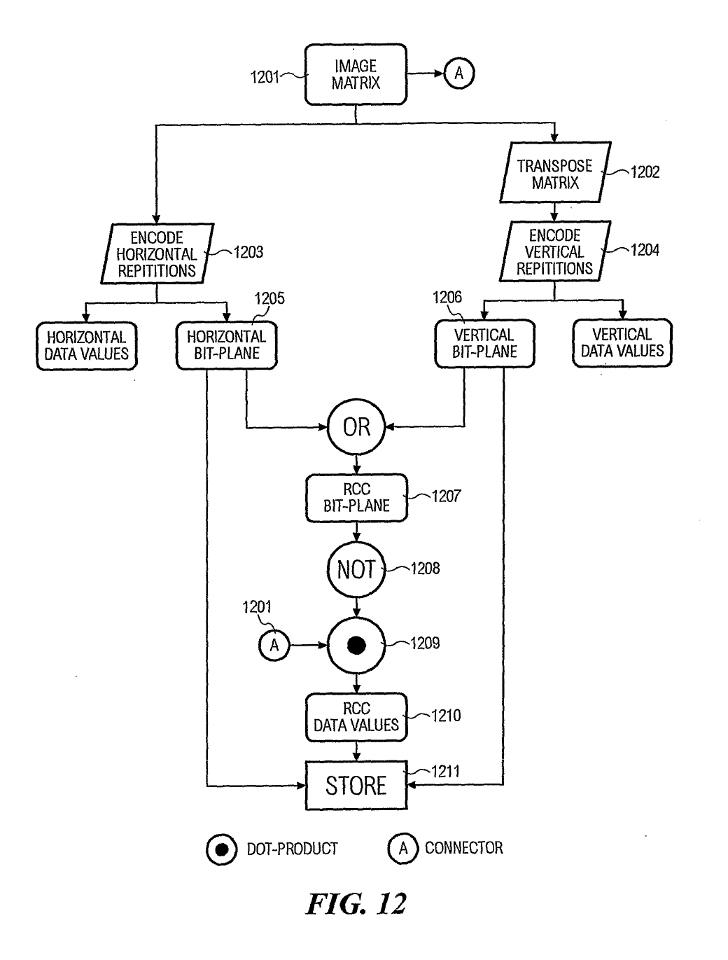

FIG. 12 shows an implementation of RCC. The image matrix 1201 is transposed 1202, encoded along the horizontal 1203 and vertical 1204 directions and the respective bit-planes 1205, 1206 are derived. Further compression is achieved by combining the horizontal and vertical bit-planes 1203, 1204 by a binary addition operation. This results in the RCC bit-plane 1207, which is logically inverted 1208 and compared 1209 with the original image matrix 1201 to obtain the final RCC data values 1210. The RCC data values 1210, together with the horizontal and vertical 1206 bit-planes are stored in a data memory 1211 for archival and future retrieval.

The encoded data can be further compressed by Huffman coding. This compression of the image data is achieved using the RCC system. This system is fast as it does not require complex transform techniques. The method may be used for any type of image file. In the example given above, the system is applied only for grayscale images. It may be applied also to colour images.

The RCC system may be applied to fields such as, for example, medical image archiving and transmission, database systems, information technology, entertainment, communications and wireless applications, satellite imaging, remote sensing, military applications.

The preferred embodiment of the present invention is based on a single mathematical operation and requires no multiplication for its implementation. This results in memory efficiency, power efficiency, and speed, in performing the compression. Because of the single mathematical operation involved, the system is reversible and lossless. This may be important for applications which demand zero loss. The compression ratios may be significantly higher than existing lossless compression schemes. RCC is a perfectly lossless data compression method by which information in highly correlated data and digital images is compacted, stored and then restored to its original format without losing or changing the information. RCC is not only a visually lossless method but is also pixel-to-pixel lossless giving zero mean square error.

Optimisation of Compression

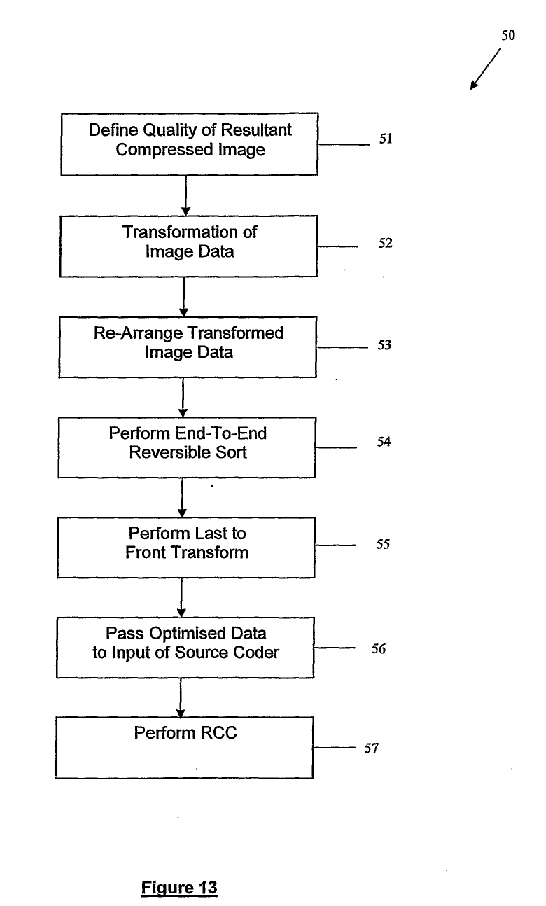

Referring to FIG. 13, a method 50 for optimising compression of image data is provided. The quality of the resultant compressed image is initially defined 51. This will determine the amount of repetition to be artificially generated in the image data. A higher amount of repetition means that a larger difference between adjacent pixels is tolerated (more lossy). If these pixels differ below a certain level they are considered to be identical. A lower amount of repetition means that the image is less lossy and visually lossless. The pre-coding block of the process is divided into two logical stages 52, 53. The first stage is transformation 52. Transformation 52 can be any one of DCT, wavelet or colour transformations. The second stage is data rearrangement 53. After the data is transformed and re-arranged, it is then directed 56 to the input of a source coder. The source coder comprises an arithmetic coder preceded by a run length encoder.

The data rearrangement stage 53 is primarily responsible for optimising the image data for compression later. This optimisation consists of an end-to-end reversible sort 54 along with a last to front transform 55. The result is that the rearranged data optimises compression by creating repetition to increase the compression ratio.

The optimisation process is scalable since the quality of the compressed image is user defined 51 at run-time. The optimisation process does not require significant changes to be made to the structure of the optimisation process. For example, when a large set of data is to be compressed into a limited amount of disk space, the choice of a compression ratio depends on the desired quality for individual images or a group of images. For Internet applications, such as streaming media and telephony applications, it is ideal for digital media developers to be able to define quality of the resultant compressed image by selecting the compression ratio.

Selected areas of an image rather than the entire image can be optimised for compression. For example, a selected region of the image can be compressed in a lossless manner, with the other regions of the image compressed in a lossy manner. This scenario is ideal for graphic artists that may want certain areas of their images to remain in perfect quality. The overhead complexity of optimising across the images is minimal, while significant gains in compression and quality are obtained.

High compression ratios are achieved while maintaining a reduced pixel-to-pixel error. The scalability of the optimisation process is maintained by exploiting the close correlation between adjacent pixels by artificially creating repetition.

Using the method, a lower Mean Square Error (MSE) is achieved compared to JPEG, JPEG2000. In JPEG, the MSE is higher due to the quantization process. Also, the method is visually lossless where the pixel-to-pixel losses are smaller in order to deliver high compression ratios.

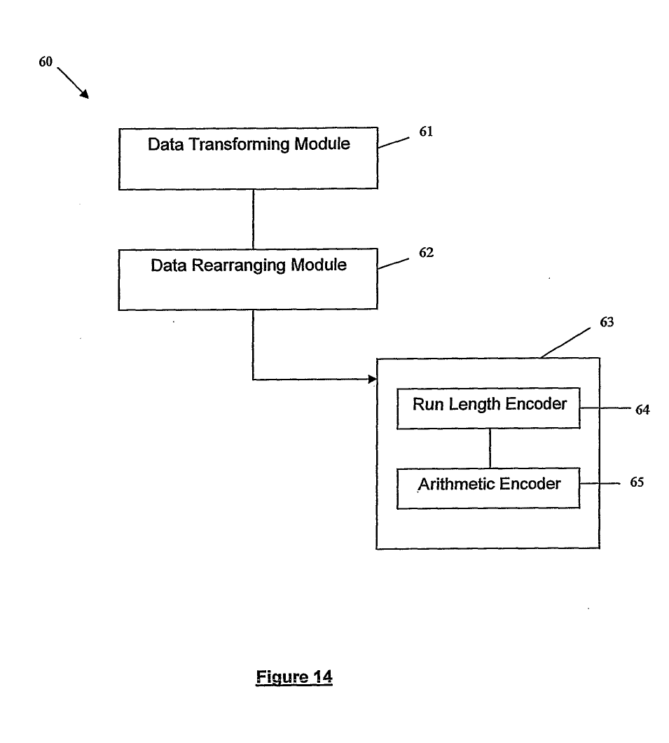

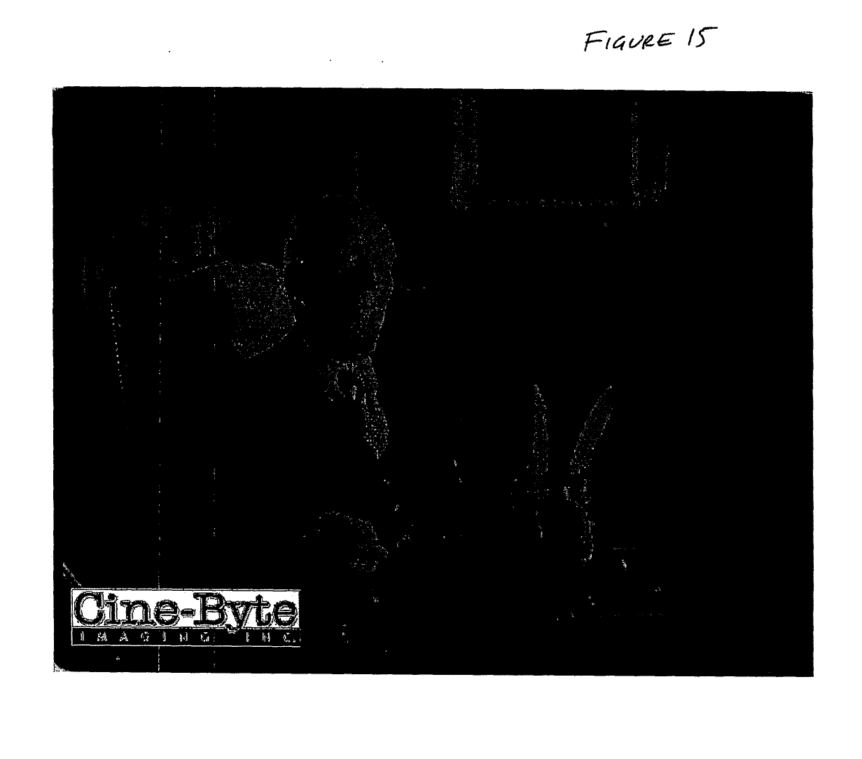

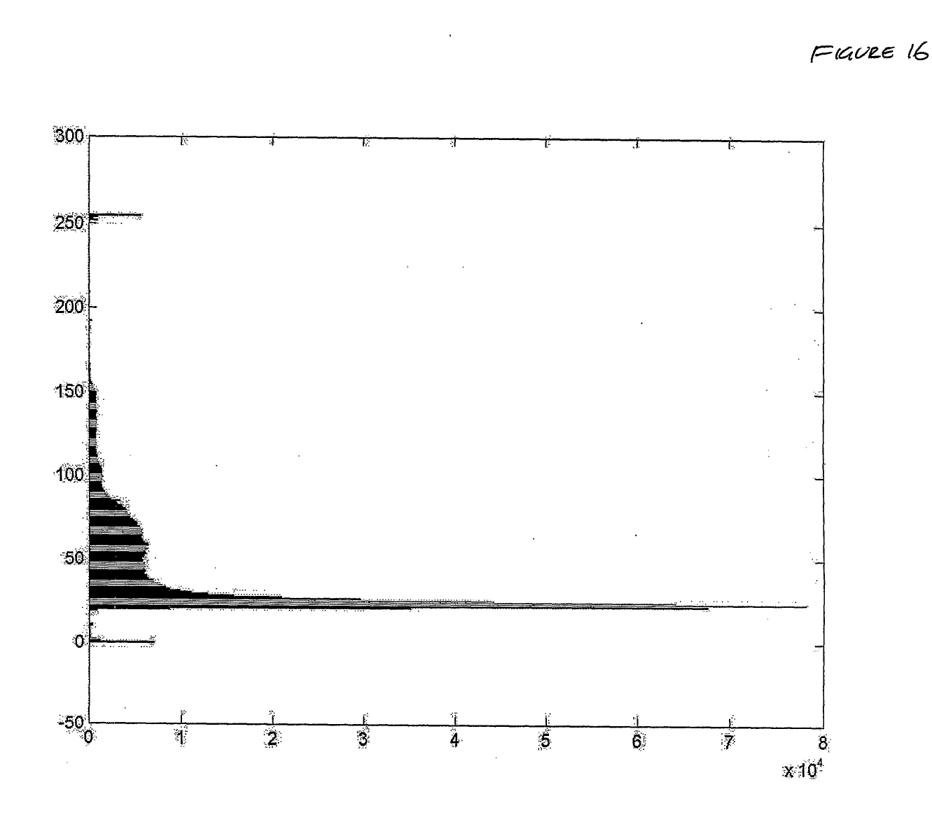

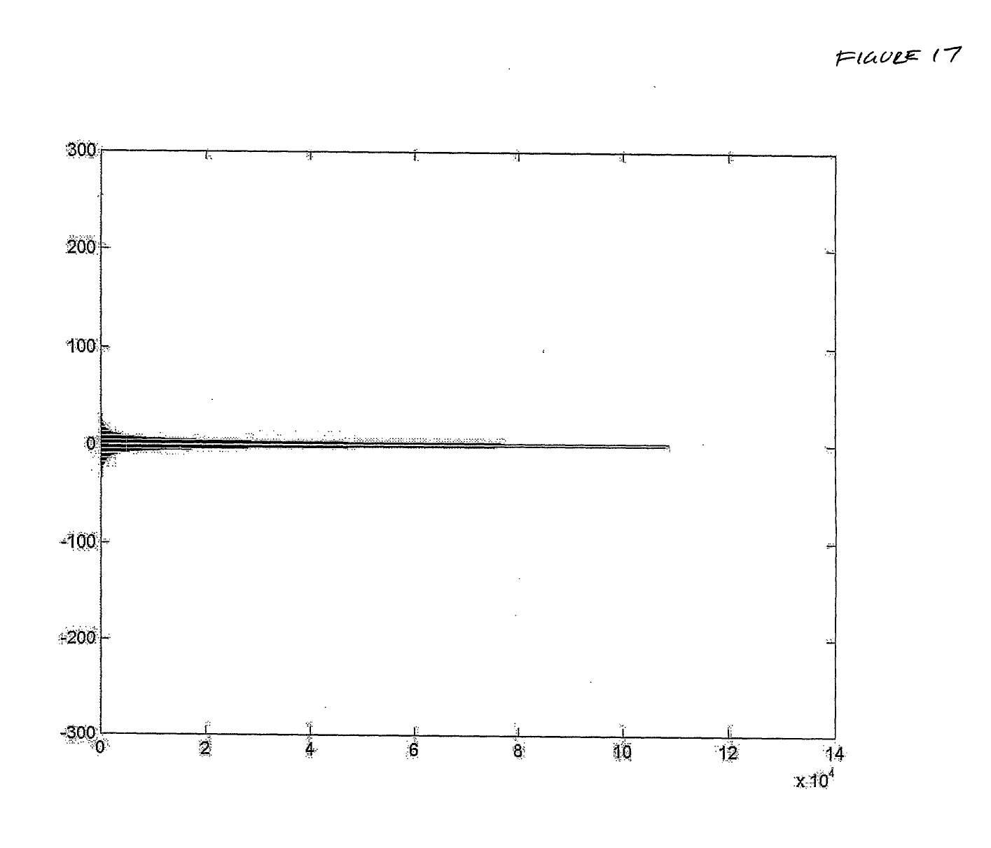

Referring to FIG. 14, optimising the compression of image data is performed by an optimisation system 60. The system 60 comprises a data transforming module 61 to transform the image data and a data rearranging module 62 to rearrange the transformed image data by artificially generating repetition of elements of the image data. The level of repetition corresponds to a predetermined level of image quality for the compressed image. The rearranged data is passed to an input of a source coder 63. The source coder 63 comprises an arithmetic coder 65 preceded by a run length encoder 64.

Additional RCC is applied 57 after the image data has been optimised for compression. In RCC, each element is compared with the previous element. If both of them are equal then a value of “1” is stored in a bit-plane. Otherwise a value of ‘0’ is stored in the bit-plane. Only the difference value is stored in a matrix, instead of storing all the repeating values.

If the application permits a lossy compression system, a modification is made to the mathematical operation so that a certain amount of loss is observed in the compression, thereby resulting in higher compression ratios. This lossy compression system would find great applications in entertainment and telecommunication systems.

In case of a lossy system of implementation, the adjacent pixels are not only compared for repetition, but also for the difference value. If the difference value between adjacent pixels is less than a given arbitrary threshold value, then the two adjacent pixels are made as the same. This further increases the number of repetitions in the image data and therefore also increases the compression ratio after applying RCC. The value of the threshold can be varied according to the requirements of the particular application, and system. The higher the threshold, the better the compression ratio and also the higher the loss in the quality of the reconstructed image.

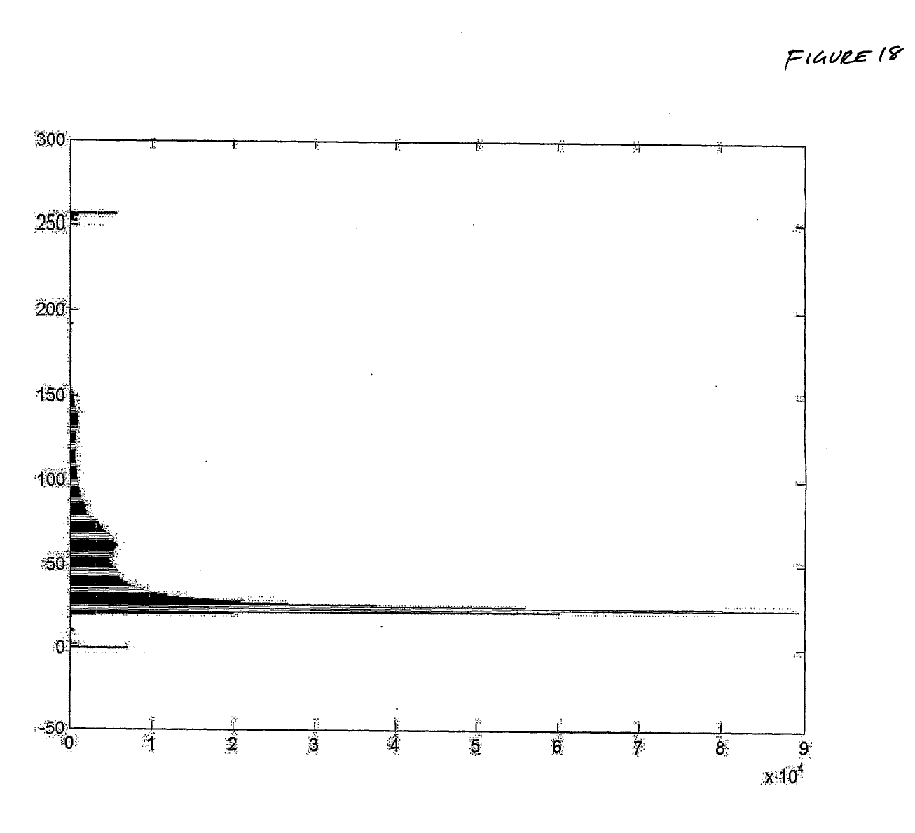

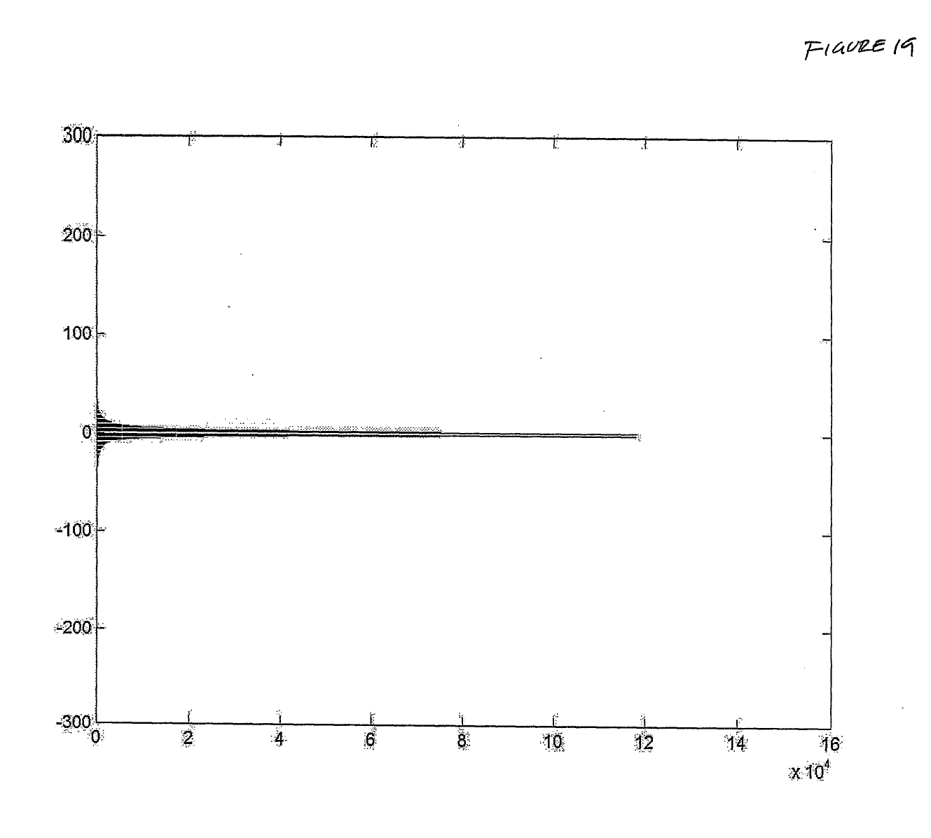

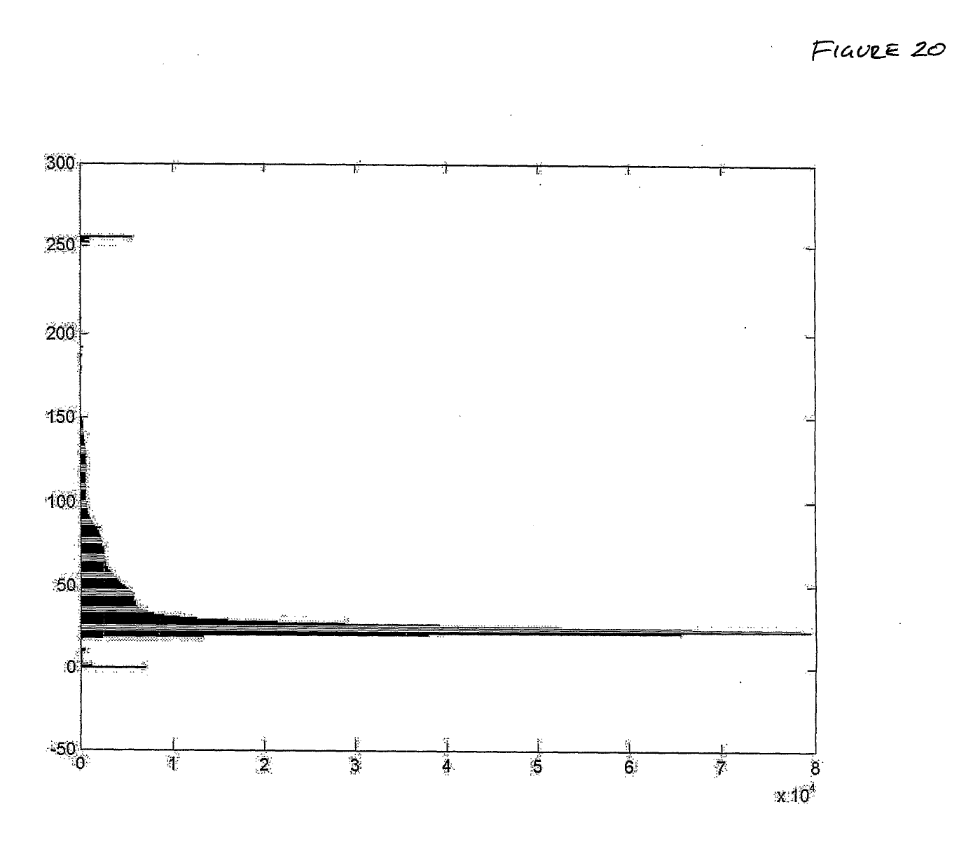

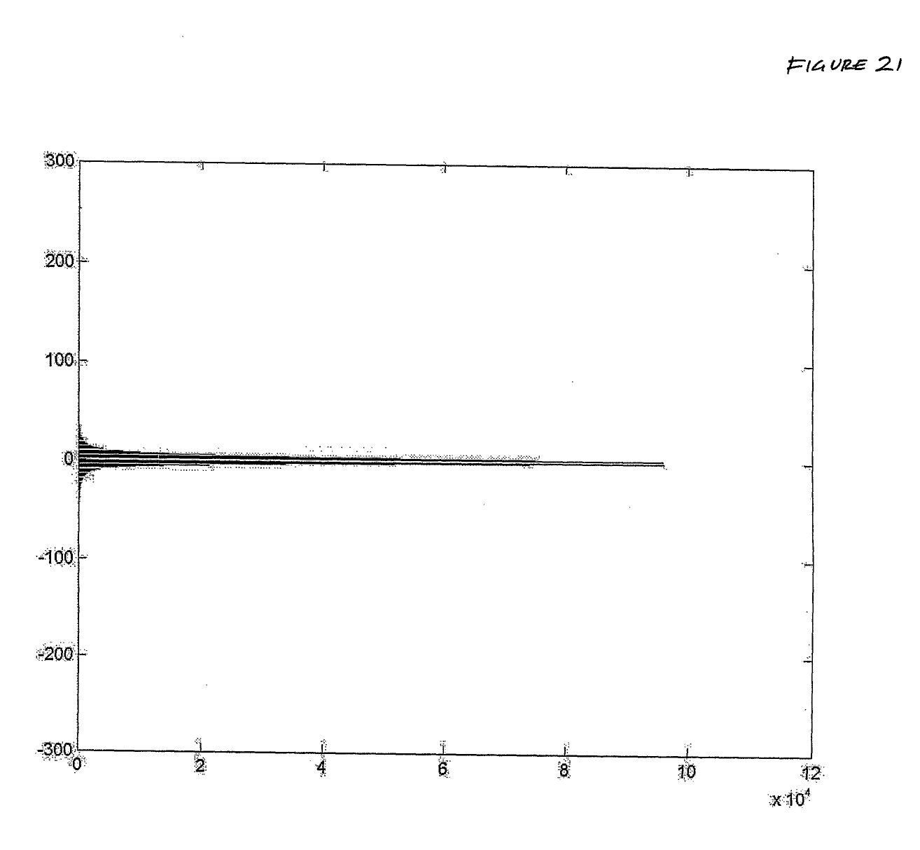

FIGS. 15 to 21 illustrate one example of RCC compression. The image in FIG. 15 is split into its Red, Green, and Blue components. The probability distribution of the occurrence of a symbol for the image is illustrated in FIGS. 16, 18 and 20. A symbol is a 8 bit data with values ranging from 0 to 255. This shows that before compression, the R, G, B components have an even distribution. However, an even distribution does not permit effective compression. Applying RCC, an uneven distribution is obtained. This is illustrated in FIGS. 17, 19 and 21. RCC compression causes the occurrence of one particular value to increase many times, and at the same time, the occurrence of other values is decreased to almost zero. This results in one group of values having a high probability of occurrence and another group of values having a negligible probability of occurrence.

Applying entropy coding principles, the values which have a high frequency of occurrence require lesser bits to be stored. Thus the distribution obtained by RCC presents an ideal scenario for compression.

RCCP Method

RCC predict transformation compares two adjacent values in raster order. If the adjacent values are the same, then the value is stored in a bit plane matrix and gives a mapping value or RCC value to the repeatedly occurring values and stores them in another data plane matrix. This method is suitable for medical images where different values repeat themselves, and these repetitions are replaced by the RCC value and the actual value is stored in the data plane matrix. This transformation only performs logical transformations to the data and still preserves the lossless nature of the transform.

In a two-dimensional performance of the method, two bit-planes are used to code the repetitions in both the horizontal and the vertical directions. This is more efficient and gives a better compression ratio. RCC multidimensional transformation is classified as RCC in two dimensions.

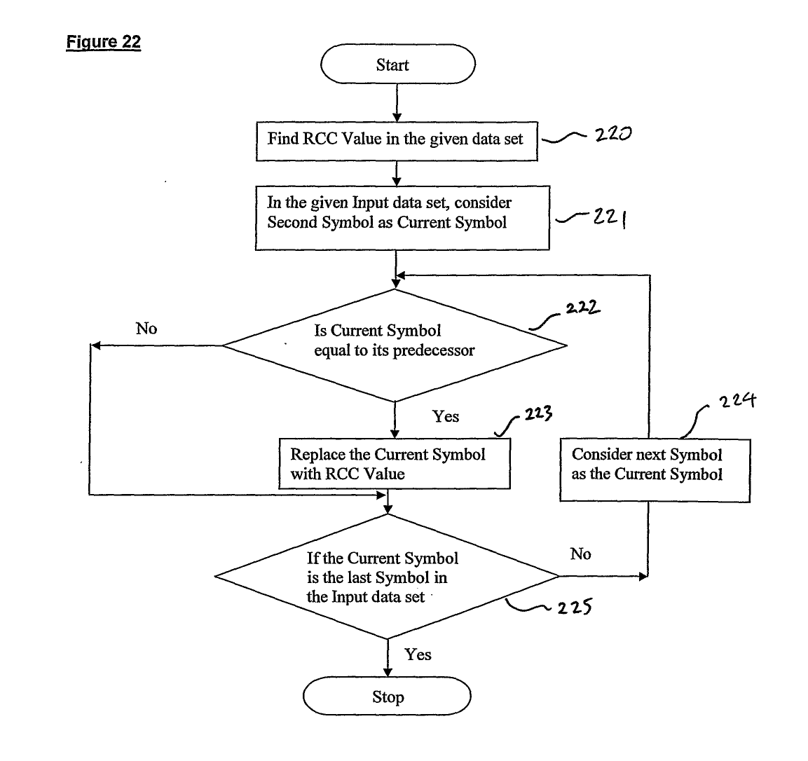

Referring to FIG. 22, the RCCP method is a fast lossless data transformation method which enhances compressibility of a given data set significantly. This is earlier described under the heading RCC predict transformation.

To perform encoding, a symbol for the RCC value must be identified and selected in the given data set 220. Any symbol that has not appeared in the given data set as RCC value is suitable. Symbols starting from 0 towards 255 are attempted to be used as the RCC value. Firstly, the symbol 0 is checked on whether it has appeared in the given data set. If 0 is not found in the data set, 0 can be used as the RCC value. Otherwise, symbol 1 is attempted and so on until a symbol is found which has not appeared in the given data set.

The RCCP method processes all the symbols in the given data set 221. In the given data set, whenever a symbol is found to be equal to its predecessor 222, then, that symbol is replaced by the RCC value 223. The RCCP method continues 224 until the last symbol in the given data set is processed 225.

| | | | | | | | | | |
|---|---|---|---|---|---|---|---|---|---|
| RCC value: | 0 | | | | | | | | |
| Given Data: | 6 | 5 | 5 | 5 | 5 | 7 | 7 | 7 | 5 |
| Position: | 0 | 1 | 2 | 3 | 4 | 5 | 6 | 7 | 8 |

In the above data set, the symbols located at positions 2, 3, 4, 6 and 7 are found to be equal to their predecessors. During encoding, these values are replaced by the RCC value, that is, symbol 0.

| | | | | | | | | | |
|---|---|---|---|---|---|---|---|---|---|
| RCC value: | 0 | | | | | | | | |
| Encoded Data: | 6 | 5 | 0 | 0 | 0 | 7 | 0 | 0 | 5 |
| Position: | 0 | 1 | 2 | 3 | 4 | 5 | 6 | 7 | 8 |

In the encoded data, the frequency of occurrence of one symbol is increased. This increase in data redundancy enhances data compression.

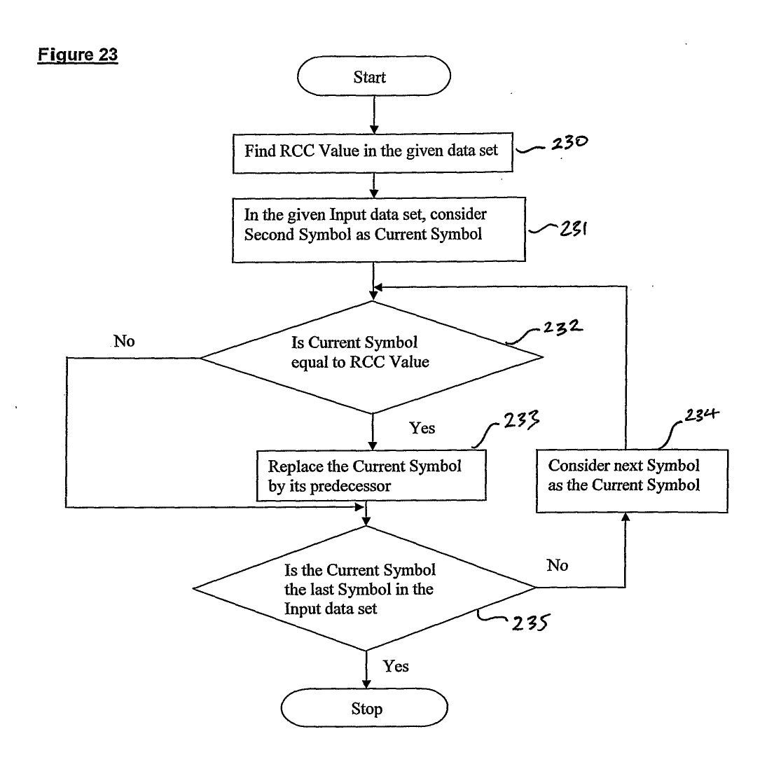

Referring to FIG. 23, to decode the encoded data, the encoded data set and the RCC value (the one that was used during encoding) are obtained 230. The RCCP method processes all the symbols in the given data set 231. During decoding, whenever the RCC value is found in the data set 232, the RCC value is replaced with its predecessor's value 233. The RCCP method continues 234 until the last symbol in the given data set is processed 235.

| | | | | | | | | | |
|---|---|---|---|---|---|---|---|---|---|
| RCC value: | 0 | | | | | | | | |
| Encoded Data: | 6 | 5 | 0 | 0 | 0 | 7 | 0 | 0 | 5 |
| Position: | 0 | 1 | 2 | 3 | 4 | 5 | 6 | 7 | 8 |

In this data set, the RCC value is found at the following positions: 2, 3, 4, 6 and 7. At the first step during this decoding process, the symbol 0 at position 2 is replaced with its predecessor, which is 5.

Now, the data set has been modified as follows:

| | | | | | | | | | |
|---|---|---|---|---|---|---|---|---|---|
| RCC value: | 0 | | | | | | | | |
| Data: | 6 | 5 | 5 | 0 | 0 | 7 | 0 | 0 | 5 |
| Position: | 0 | 1 | 2 | 3 | 4 | 5 | 6 | 7 | 8 |

Next, to decode the value at position 3, the value 5 (new value) located at position 2 is used. Now, the data set has been modified as follows:

| | | | | | | | | | |
|---|---|---|---|---|---|---|---|---|---|
| RCC value: | 0 | | | | | | | | |
| Data: | 6 | 5 | 5 | 5 | 0 | 7 | 0 | 0 | 5 |
| Position: | 0 | 1 | 2 | 3 | 4 | 5 | 6 | 7 | 8 |

Similarly, the rest of the data set is decoded. Finally, the resulting decoded data set is as follows:

| | | | | | | | | | |
|---|---|---|---|---|---|---|---|---|---|
| RCC value: | 0 | | | | | | | | |
| Decoded Data: | 6 | 5 | 5 | 5 | 5 | 7 | 7 | 7 | 5 |
| Position: | 0 | 1 | 2 | 3 | 4 | 5 | 6 | 7 | 8 |

This data set is same as the original input data set. This illustrates the RCC encoding and decoding process on a given set of data.

RCCA Method

The RCC Adaptive (RCCA) method is a variation of the RCCP method described. One limitation of the RCCP method is that it cannot be applied to a data set that has one or more appearance of all the 256 symbols. This is because in the RCCP method, a symbol that has made an appearance in the input data set cannot be considered as an RCC value. This limitation is eliminated by the RCCA method. The RCCA method makes it possible to use any symbol as the RCC value irrespective of whether it appears in the given data set.

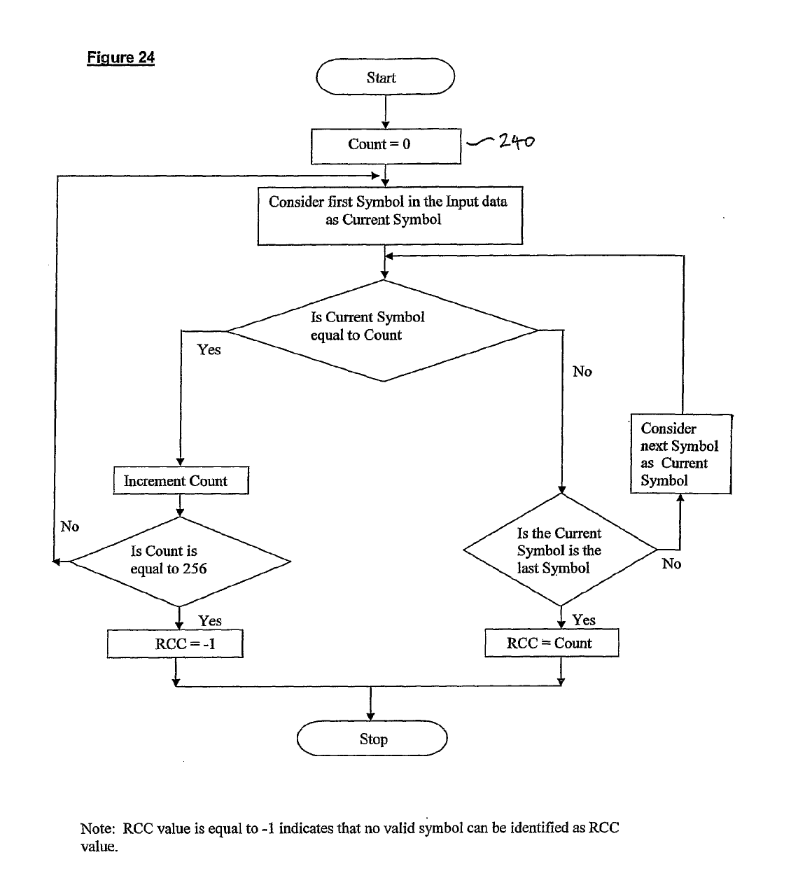

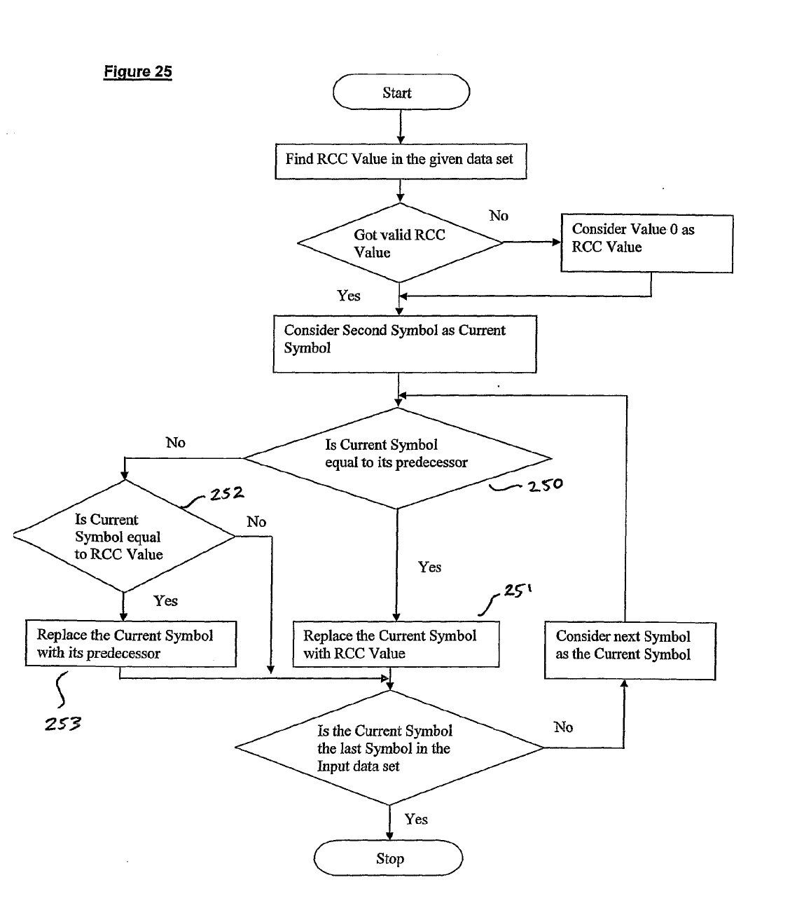

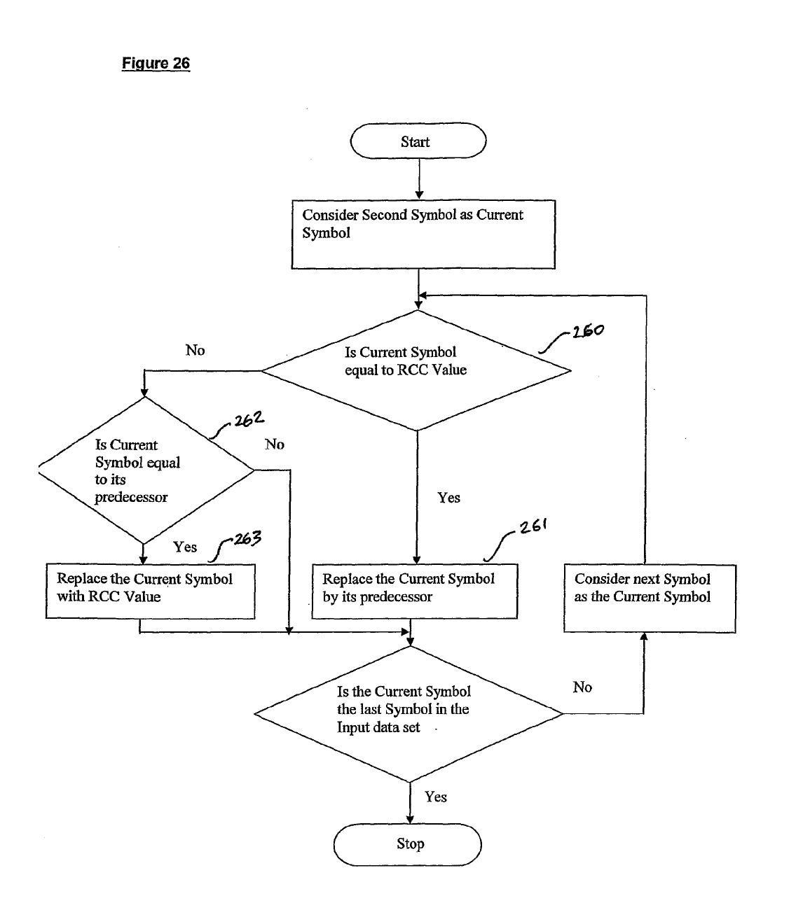

Referring to FIG. 24, initially, a symbol which has not occurred in the given data set is searched 240. If one is found, then this symbol is considered as the RCC value. If one is not found, any of the symbols can be selected as the RCC value. In most circumstances, symbol 0 is selected as the RCC value.

Referring to FIG. 5, similarly to the RCCP method, whenever a symbol is found to be equal to its predecessor 250, it is replaced by the RCC value 251. Whenever a symbol is found not equal to its predecessor, but equal to the RCC value 252, that symbol is replaced by its predecessor 253.

For example, if the symbol 0 is selected as the RCC value to encode the given set of data 9, 5, 5, 8, 0, 0, 0, 6, 0, 6.

| | | | | | | | | | | |
|---|---|---|---|---|---|---|---|---|---|---|
| RCC value: | 0 | | | | | | | | | |
| Given data: | 9 | 5 | 5 | 8 | 0 | 0 | 0 | 6 | 0 | 6 |
| Position: | 1 | 2 | 3 | 4 | 5 | 6 | 7 | 8 | 9 | 10 |

The value at Position 3 is equal to its predecessor, and it is replaced with the RCC value. This produces the following data set:

| | | | | | | | | | | |
|---|---|---|---|---|---|---|---|---|---|---|
| RCC value: | 0 | | | | | | | | | |
| Data: | 9 | 5 | 0 | 8 | 0 | 0 | 0 | 6 | 0 | 6 |
| Position: | 1 | 2 | 3 | 4 | 5 | 6 | 7 | 8 | 9 | 10 |

At position 5, the symbol is equal to RCC value, but, not equal to its predecessor. So, that symbol is replaced by its predecessor. The symbols at position 6 and 7 remain unchanged because they are equal to their respective predecessors. After encoding until position 7, the data set is as follows:

| | | | | | | | | | | |
|---|---|---|---|---|---|---|---|---|---|---|
| RCC value: | 0 | | | | | | | | | |
| Data: | 9 | 5 | 0 | 8 | 8 | 0 | 0 | 6 | 0 | 6 |
| Position: | 1 | 2 | 3 | 4 | 5 | 6 | 7 | 8 | 9 | 10 |

The value at Position 9 is not equal to its predecessor, but equal to RCC value, so it is replaced by its predecessor. At the same time, the Symbol at Position 10 will remain unchanged because it is neither equal to its predecessor nor equal to the RCC value.

Therefore, the encoded data after RCCA has completed is as follows:

| | | | | | | | | | | |
|---|---|---|---|---|---|---|---|---|---|---|
| RCC value: | 0 | | | | | | | | | |
| Encoded Data: | 9 | 5 | 0 | 8 | 8 | 0 | 0 | 6 | 6 | 6 |
| Position: | 1 | 2 | 3 | 4 | 5 | 6 | 7 | 8 | 9 | 10 |

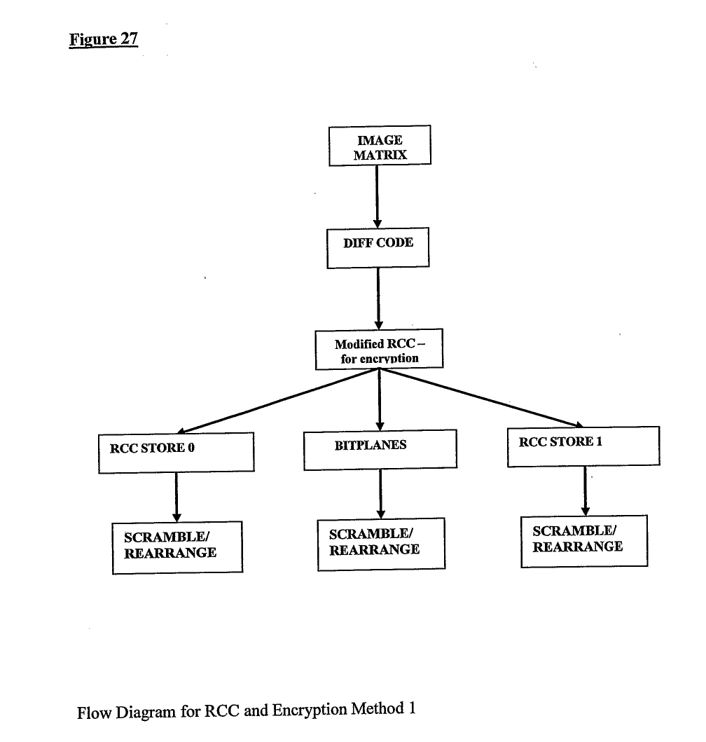

Referring to FIG. 26, to perform the decoding process, the encoded data set and the RCC value are required. During decoding, if a symbol is equal to RCC value 260, then it is replaced by its predecessor 261. If the symbol is not equal to RCC value, but equal to its predecessor 262, then it is replaced by RCC value 263. If the symbol is neither equal to the RCC value nor equal to its predecessor, then it is left unchanged.

| | | | | | | | | | | |
|---|---|---|---|---|---|---|---|---|---|---|
| RCC value: | 0 | | | | | | | | | |
| Encoded Data: | 9 | 5 | 0 | 8 | 8 | 0 | 0 | 6 | 6 | 6 |
| Position: | 1 | 2 | 3 | 4 | 5 | 6 | 7 | 8 | 9 | 10 |

The value at position 3 is equal to RCC value, so it is replaced by its predecessor which is 5. The resulting data set is as follows:

| | | | | | | | | | | |
|---|---|---|---|---|---|---|---|---|---|---|
| RCC value: | 0 | | | | | | | | | |
| Data: | 9 | 5 | 5 | 8 | 8 | 0 | 0 | 6 | 6 | 6 |
| Position: | 1 | 2 | 3 | 4 | 5 | 6 | 7 | 8 | 9 | 10 |

The value at position 4 remains unaffected because it is neither equal to RCC value nor equal to its predecessor. The value at position 5 is equal to its predecessor. So, it is replaced by the RCC value. The resulting data set is as follows:

| | | | | | | | | | | |
|---|---|---|---|---|---|---|---|---|---|---|
| RCC value: | 0 | | | | | | | | | |
| Data: | 9 | 5 | 5 | 8 | 0 | 0 | 0 | 6 | 6 | 6 |
| Position: | 1 | 2 | 3 | 4 | 5 | 6 | 7 | 8 | 9 | 10 |

The value at position 6 and 7 are equal to the RCC value. So, they are replaced by the predecessor of position 6 which is also equal to the RCC value. Thus, they remain unaffected. The value at position 9 is equal to its predecessor and therefore is replaced by the RCC value.

The resulting decoded data is as follows:

| | | | | | | | | | | |
|---|---|---|---|---|---|---|---|---|---|---|
| RCC value: | 0 | | | | | | | | | |
| Decoded Data: | 9 | 5 | 5 | 8 | 0 | 0 | 0 | 6 | 0 | 6 |
| Position: | 1 | 2 | 3 | 4 | 5 | 6 | 7 | 8 | 9 | 10 |

Thus, when the decoding process is completed, the original set of data is obtained.

Applications

RCC can be used in applications for medical imaging, digital entertainment and document management. Each of these verticals requires RCC to be implemented in a unique way to deliver a robust and powerful end product.

RCC can be deployed in the following forms for commercialisation:

1) ASIC or FPGA chips

2) DSP or embedded systems

3) Standalone hardware boxes

4) Licensable software (as DLLs or OCX)

5) Software deliverables

Although the bit-plane transformation is necessary in order for re-arrangement, other pre-processing or post-processing transformation is optional and not mandatory.

Although a specific sequence for compressing an image is described, the present invention is not limited or restricted to any particular order. In one embodiment, transformation is performed before re-arrangement. In another embodiment, transformation is performed twice, one before re-arrangement and one after re-arrangement. In a further embodiment, re-arrangement is performed twice.

RCC Encryption

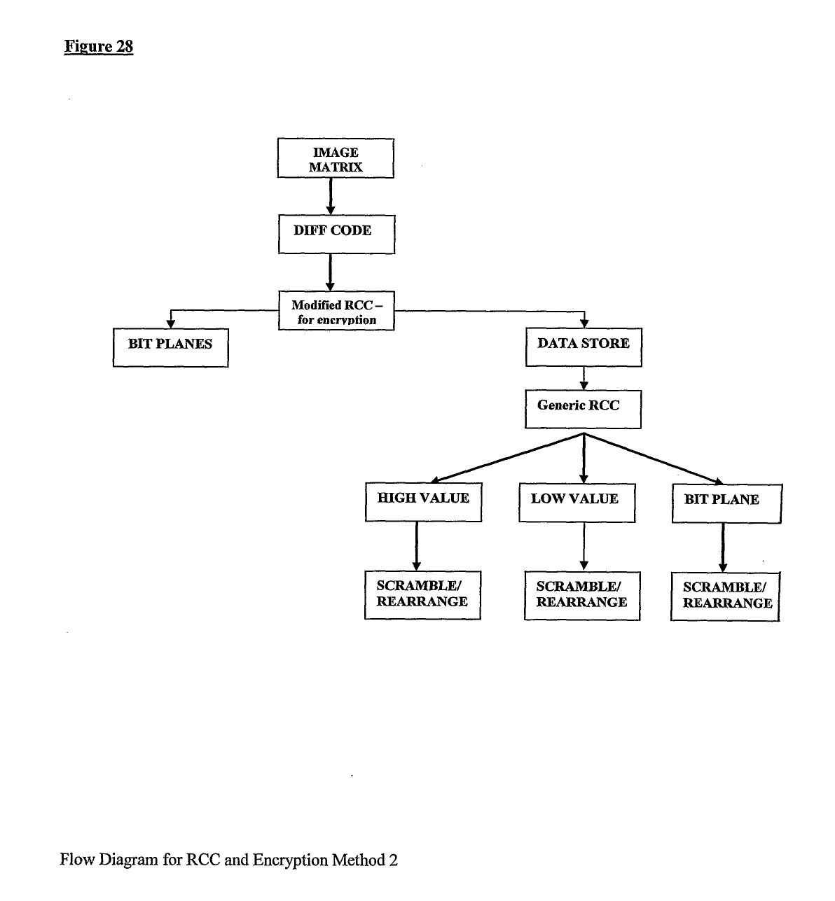

Referring to FIGS. 27 and 28, two methods for encrypting data are provided. RCC with encryption support is a modification of the generic RCC method described earlier. The generic RCC method forms a framework that is used by the encryption modules.

Data-scrambling mechanisms in RCC translates compressed data into a secret code. To achieve an effective data security system without any loss of data or time, RCC encryption converts the compressed data and encodes into a form that is incomprehensible by means of a key, so that it can be reconverted only by an authorized recipient holding the matching key

RCC derives its security from the inherent randomness in shuffled image data. By manipulating the image data, a set of N×N (size of image) “random” values are created that is then combined with the compressed data.

The output of RCC contains two matrices namely Values Stored (referred to as RCC Store0 and RCC Store1) and Bitplane. It is clear that the above transform is integer to integer based and hence perfectly reversible. To perfectly reconstruct the image, RCC Store and Bitplane matrices are made available to the reconstruction algorithm. RCC achieves encryption by modifying the contents of RCC store in a manner which the reconstruction algorithm also knows the decryption algorithm to proceed with the reconstruction.

RCC Encryption Method 1

Turning to FIG. 27, the first encryption method comprises pre-processing and post-processing steps that are added before and after RCC, respectively. The pre-processing step includes a Diff Code module and the post-processing step uses a scrambling method that modifies the spatial properties of the data.

Pre-Processing

The Diff Code module estimates the rate of change of the intensity and/or color in the image. This separates the image into areas of high intensity changes and low intensity changes. In an image there are several small regions whose rate(s) of change of intensity are the same, and the Diff Code module ensures that such regions are identified and classified into the same group. The probability distribution of the data is modified the Diff Code module in a manner to augment compression. This process is an integer-to-integer process and does not affect the lossless property of the method.

The Diff Code process is explained. Any pixel (p) can be indexed using the following convention p(i, j). This convention applies since the pixel ‘p’ can be found in the ‘i^{th}’ row and ‘j^{th}’ column. Therefore any pixel ‘p’ is defined as follows:
p(i,j)=p(i,j)−p(i−1,j) for all i>0 and j>=0
and
p(i,j)=p(i,j) for all i=0 and j>=0

The row and column numbers are indexed beginning with ‘0’.

RCC is then applied to the Diff Cod(ed) data. A small novelty is introduced into the Generic RCC which further helps to encrypt the data. Generic RCC produces two matrices namely RCC store and Bitplane. The novelty introduced here produces three matrices, two RCC store matrices (RCC StoreO and RCC Storel) and a Bitplane matrix. One RCC store matrix (RCC StoreO) contains values from the Diff Coded matrix that lie within a particular range of values. This range is called Diff Code Range which will be chosen based on the probability distribution of the Diff Coded data. The other RCC store matrix contains all the values that lie outside the Diff Code Range. The bitplane matrix assumes the same significance as in the Generic RCC method except that ‘zeros’ and ‘ones’ indicate that values have to restored from the RCC Store0 matrix and RCC Store1 matrix, respectively, during decoding

To achieve this, a pivot value (P) is chosen from the Diff Coded data (D) based on the probability distribution of the data. The Diff Code Range (DR) is defined as
DR=P−Δ<D<P+Δ

Where ΔεZ is a small positive value chose based on the probability distribution of the data. Z is the set of integers.

Post-Processing

The three output matrices of the RCC stage are further scrambled to enhance the encryption process.

This data is then finally compressed using a source encoder such as Huffman or Arithmetic Coders.

RCC Encryption Method 2

Turning to FIG. 28, the second encryption method comprises pre-processing and post-processing steps that are added before and after RCC, respectively. The pre-processing step includes a Diff Code module and the post-processing step includes a scrambling method that modifies the spatial properties of the data.

Pre-Processing

The Diff Code module estimates the rate of change of the intensity and/or color in the image. This separates the image into areas of high intensity changes and low intensity changes. In an image there are several small regions whose rate(s) of change of intensity are the same, and the Diff Code module ensures that such regions are identified and classified into the same group. The probability distribution of the data is modified the Diff Code module in a manner to augment compression. This process is an integer-to-integer process and does not affect the lossless property of the method.

The Diff Code process is explained. Any pixel (p) can be indexed using the following convention p(i, j). This convention applies since the pixel ‘p’ can be found in the ‘i^{th}’ row and ‘j^{th}’ column. Therefore any pixel ‘p’ is defined as follows:
p(i,j)=p(i,j)−p(i−1,j) for all i>0 and j>=0
and
p(i,j)=p(i,j) for all i=0 and j>=0

The Diffcoded Data is then re-aligned as a one dimensional data sequence instead of an image matrix. This linearized Diffcoded Data forms the input for the RCC modules.

The row and column numbers are indexed beginning with ‘0’.

RCC Modules

The Diff Cod(ed) data is then coded using generic RCC. This produces two matrices namely RCC Store and one Bitplane matrix (this is because only the horizontal bitplane is required since the data has been linearized into a one-dimensional data sequence). The RCC store is then applied to the Diff Cod(ed) data as described earlier. This further produces another bitplane matrix and two RCC Store matrices. These three matrices in addition to the biplane matrix of the generic RCC forms the input to the Post Processing stage.

Post-Processing

The four output matrices of the RCC phase are further scrambled to enhance the encryption process. This data is then finally compressed using a source encoder such as Huffman or Arithmetic Coders.

Whilst there has been described in the foregoing description a preferred embodiment of the present invention, it will be understood by those skilled in the technology that many variations or modifications in details of design, constructions or operation may be made without departing from the present invention.

1. A method for encrypting highly correlated data wherein each element is compared with a previous element and:
(a) if they are both equal, a first value is recorded;
(b) if they are not both equal, a second value is recorded; and
(c) wherein an encryption layer is added.

2. The method as claimed in claim 1, wherein adding the encryption layer comprises a pre-processing and post-processing step, the pre-processing step estimating the rate of change of the intensity and/or color in the image, and separating the image into areas of high intensity changes and low intensity changes; and the post-processing step scrambling the recorded values.

3. The method as claimed in claim 1, wherein the data is image data.

4. The method as claimed in claim 3, wherein each element is a pixel.

5. The method as claimed in claim 1, wherein the first value is a 1, and the second value is a 0.

6. The method as claimed in claim 1, wherein the first and second values are stored in a bit plane.

7. The method as claimed in claim 6, wherein for a one-dimensional compression, a single bit plane is used to store the values.

8. The method as claimed in claim 6, wherein for a two-dimensional compression, comparison is in both horizontal and vertical directions, a separate bit plane being used for each direction.

9. The method as claimed in claim 8, wherein the bit-planes for the horizontal and vertical directions are combined by binary addition to form a repetition coded compression bit-plane.

10. The method as claimed in claim 9, wherein the combining is by binary addition, only the second values being stored for lossless reconstruction of the data.

11. The method as claimed in claim 10, wherein the result of the combining is repetition coded compression data values, all other data values being able to be reconstructed using the repetition coded compression data values, and the bit planes for the horizontal and vertical directions.

12. The method as claimed in claim 1, wherein storage in bit planes is in a matrix.

13. The method as claimed in any one of claim 1, wherein a single mathematical operation is performed for each element.

14. An encryption system for encrypting highly correlated data using repetition coded compression, the system comprising:
(a) a data receiver for receiving digital data;
(b) a reshaping block for rearranging the digital data into a matrix of data values;
(c) a processor for receiving the matrix of data values and compressing the data values to form compressed data;
(d) a memory for storage of the compressed data;
(e) an encryption module for adding an encryption layer to mathematically manipulate the compressed data.

15. A method for encrypting data comprising:
(a) receiving digital data;
(b) reshaping the digital data into a digital data matrix;
(c) encoding repetitions in the digital data matrix into a bit-plane index, and stored data values; and
(d) storing the compressed data in a storage memory in an encrypted form.

16. The method as claimed in claim 15, wherein there the bit-planes containing information regarding the repetitions along horizontal and vertical directions.

17. The method as claimed in claim 16, further including combining the horizontal and vertical bit-planes by a binary addition operation to give a repetition coded compression bit-plane.

18. The method as claimed in claim 17, further including comparing the repetition coded compression bit-plane with the digital data matrix to obtain final repetition coded compression data values.

19. The method as claimed in claim 18, further including storing and archiving the repetition coded compression data values along with the horizontal and vertical bit-planes.

20. The method as claimed in claim 15, wherein the method is used for an application selected from the group consisting of: medical image archiving, medical image transmission, database system, information technology, entertainment, communications applications, and wireless application, satellite imaging, remote sensing, and military applications.
